(19) United States
(12) Patent Application Publication
(10) Pub. No.: US 2026/0330003 A1
(43) Pub. Date: Oct. 22, 2026

(54) METHOD AND IDENTIFICATION SYSTEM FOR GENERATING A DIGITAL AGENT IDENTIFIER IN A VIRTUAL SPACE

(71) Applicant: Nayutam&Co., Tokyo (JP)

(72) Inventor: Eizaburo IWATA, Tokyo (JP)

(21) Appl. No.: 19/651,788

(22) Filed: Apr. 20, 2026

Related U.S. Application Data
(63) Continuation of application No. PCT/JP2024/037592, filed on Oct. 22, 2024.

(30) Foreign Application Priority Data
Nov. 6, 2023 (JP) 2023-188997

(51) Int. Cl. G06F 21/45

(52) U.S. Cl. CPC G06F 21/45

(57) ABSTRACT

A digital agent identification technology is provided for reliably associating a user with a digital agent acting autonomously in a virtual space. Biometric data obtained from a biometric part of the user is processed to extract user specific biometric features, which are transformed into binary data. The binary data is divided into 2 bit identification monomers and arranged in a chain like identification sequence used as an identifier of the digital agent. The identification sequence may be edited through mutation, recombination, substitution, inversion, deletion, insertion, or encryption, or may replace a part of a reference sequence to generate the identifier. Identification sequences of multiple digital agents may be combined to produce a new digital agent, and genealogical information may be stored in a server. The invention enables secure, scalable identification of digital agents and accurate association with the corresponding user.

### CROSS-REFERENCE TO RELATED APPLICATIONS

This Application claims the benefit of priority and is a Continuation application of the prior International Patent Application No. PCT/JP2024/037592, with an international filing date of Oct. 22, 2024, which designated the United States, and is related to the Japanese Patent Application No. 2023-188997, filed Nov. 6, 2023, the entire disclosures of all applications are expressly incorporated by reference in their entirety herein.

### TECHNICAL FIELD

The present disclosure relates to a digital agent that acts autonomously in a digital space as a personal agent of a user. More specifically, the present disclosure provides an identification system and method with high security and scalability that associates a digital agent, which serves as a digital persona of a user in the digital space, with the owner (user) of the digital agent by utilizing the user's own biometric features during the generation of an identifier.

### BACKGROUND ART

While digital agents include characters (avatars) that serve as a user's alter ego, there is an increasing need to reliably associate a user with a digital agent as its role evolves into an autonomous personal agent. Since biometric authentication utilizes highly unique, individual-specific information for authentication, it is considered a suitable technology for such identification. However, when biometric authentication is applied to a virtual space, it generally requires a user to perform an authentication action at each instance where authentication is needed, such as during login or payment. Therefore, conventional biometric authentication is not necessarily suitable for identifying or authenticating autonomous digital agents.

For example, Japanese Patent Application Publication No. 2007-249317 (Patent Document 1) proposes a biometric authentication system in “Dot City,” where electronic data is used to simulate a real streetscape to ensure secure and reliable transactions, such as shopping, entertainment, sports, and financial internet transactions. Specifically, a streetscape authentication registration office is established; to prove that a user is legitimate, the user moves a cursor to the registration office to perform registration and verification. It further describes using images of the user's face or head captured by a camera on a user terminal, or adding data such as fingerprints, voiceprints, or retinas.

Japanese Patent Application Publication No. 2010-9512 (Patent Document 2) proposes a user identification step in a virtual space provided via a network, executed by a server device that controls conversations held by a digital agent and a terminal connected to the server device. This identification is based on digital agent IDs or location information and does not require biometric authentication.

International Publication No. WO2018/071826 (Patent Document 3) states that many applications for games, content consumption, and productivity have been developed using virtual reality (VR) technology to provide immersive experiences, and these VR applications may allow in-app purchases, user customization, or parental controls. It suggests that these operations should require user identification and authentication for security, for which biometric authentication is effective. Specifically, it proposes using security authentication based on biometric characteristics for a target service in a computer-implemented method for virtual service implementation. For instance, it describes using fingerprints as biometric characteristics and fingerprint recognition hardware. These methods of using biometric authentication serve as a trigger for a user to securely utilize immersive services and do not suggest application to autonomous digital agents.

International Publication No. WO2018/102246 (Patent Document 4) proposes a step of determining whether a virtual reality client terminal is currently being used by a real person based on blink recognition or heartbeat recognition. It also presents a step of presenting a notification in a virtual reality scenario to perform biometric authentication in response to determining that the terminal is used by a real person. The physiological features of the eye used are eye patterns and iris features. Naturally, to implement a service based on a virtual reality scenario, the user is required to be present at the site of implementation.

International Publication No. WO2011/129543 (Patent Document 5) presents a new scheme for an apparatus and method applied to a virtual world sensed from the real world using bending sensors. The sensor characteristics are defined as metadata encoded in a binary format.

Japanese Patent Application Publication No. 2022-187424 (Patent Document 6) proposes a program, an information management system, and an information management method that can guarantee the authenticity of a digital agent in a virtual space and contribute to efficient management or transaction of usage rights in the virtual space. This is achieved by processing video data into motion-encoded data (information arranged in time series) and generating an authentication token corresponding to the digital agent based on the motion-encoded data.

Japanese Patent Application Publication No. 2008-217255 (Patent Document 7) proposes a system for recording user information, including appearance information representing a user's physical features and/or personality information representing a user's psychological features, in association with a digital agent to facilitate efficient communication with other users. Fingerprint authentication is utilized in this system.

International Publication No. WO2011/090284 (Patent Document 8) proposes an interworking system and method between a plurality of heterogeneous distributed virtual worlds using globally unique distributed object identification IDs. Unlike conventional closed virtual worlds, open virtual worlds allow sharing of various object information between heterogeneous virtual worlds. The system is intended for applied services such as allowing a digital agent belonging to a specific virtual world to move and act freely in other virtual worlds and exchange information with other digital agents.

Furthermore, the present inventor proposed in International Publication No. WO2013/136553 (Patent Document 9) a method of capturing a palm image using a visible light camera, such as those mounted on smartphones, to extract palm print shapes and vein shapes, generate authentication data, and perform individual authentication using similarity (correlation between images) with template data. This document describes an example of generating authentication and template data using Hough transform and polar coordinate transform.

### PRIOR ART DOCUMENTS

### Patent Documents

Patent Document 1: Japanese Patent Application Publication No. 2007-249317.

Patent Document 2: Japanese Patent Application Publication No. 2010-9512.

Patent Document 3: International Publication No. WO2018/071826.

Patent Document 4: International Publication No. WO2018/102246.

Patent Document 5: International Publication No. WO2011/129543.

Patent Document 6: Japanese Patent Application Publication No. 2022-187424.

Patent Document 7: Japanese Patent Application Publication No. 2008-217255.

Patent Document 8: International Publication No. WO2011/090284.

Patent Document 9: International Publication No. WO2013/136553.

### SUMMARY OF THE INVENTION

### Problems to be Solved by the Invention

A problem to be solved is that conventional technologies manage rights and authentication by identifying a user through biometric authentication, passwords, or the like at the time of login or service usage, based on the premise of displaying a user's alter ego character in a virtual space. However, digital agents playing various roles—such as autonomous digital agents, AI digital agents, and cybernetic digital agents—are personal agents that act and operate autonomously in a literal sense in the virtual space. Consequently, conventional authentication and identification methods that assume the presence of the user at the site cannot adequately address these new roles.

The present disclosure has been made in view of the above points, and an object thereof is to provide an identifier generation method and an identification system for a digital agent that associates a user with a digital agent using an identifier generated from the user's biometric information. More specifically, individual features extracted from a user's biometric parts commonly used in biometric authentication—such as the face, vascular patterns, iris, or fingerprints—are incorporated into the identifier of the digital agent. This method enables the identification of a digital agent and realizes association between the user and the digital agent with high accuracy equivalent to biometric authentication.

Furthermore, by configuring the identifier incorporated into the digital agent with a sequence structure similar to biological DNA, it becomes possible to apply biological diversity, such as mutation and recombination, to identifier generation, thereby providing an identification system with excellent confidentiality. Moreover, as digital agents are expected to increase exponentially in the future, the present disclosure provides a method and system that enable reliable digital agent identification and user authentication, thereby addressing the increasing complexity of rights and interests related to digital agents.

The present invention can be expressed as the following aspects.

(Item 1) A method for generating an identifier for associating a user with a digital agent acting as a digital persona of the user in a digital space, the method comprising:

obtaining biometric data from a biometric part of the user;

extracting, by a processor, user specific biometric features from the biometric data;

transforming, by the processor, the user-specific biometric features into binary data suitable for computer processing;

dividing, by the processor, the binary data into a plurality of identification monomers, each identification monomer corresponding to a 2-bit unit of the binary data;

generating an identification sequence comprising a chain-like array of the plurality of identification monomers; and

defining an identifier of the digital agent based on the identification sequence.

(Item 2) The method according to claim 1, wherein the identifier of the digital agent is the identification sequence.

(Item 3) The method according to claim 1, further comprising editing the identification sequence by performing at least one of mutation, recombination, substitution, inversion, deletion, insertion, or encryption, and defining the edited identification sequence as the identifier of the digital agent.

(Item 4) The method according to claim 1, further comprising providing a reference sequence and replacing a part of the reference sequence with the identification sequence to generate the identifier of the digital agent.

(Item 5) The method according to claim 4, wherein the identifier of the digital agent is defined as position information on the reference sequence where the replacement was performed.

(Item 6) The method according to any one of claims 1 to 5, further comprising generating a third identification sequence for a third digital agent based on a first identification sequence of a first digital agent and a second identification sequence of a second digital agent.

(Item 7) The method according to claim 6, further comprising storing, in a server, genealogical information representing a relationship among the first digital agent, the second digital agent, and the third digital agent.

(Item 8) The method according to any one of claims 1 to 7, wherein the digital agent further comprises a trait sequence in addition to the identification sequence, the trait sequence including at least one determinant of a shape, a style, a color, a personality, a property, an intelligence, an intellect, a gender, or a species of the digital agent.

(Item 9) The method according to any one of claims 1 to 8, wherein a data array of the identifier has a single-stranded structure or a double stranded structure in which single stranded data arrays are complementarily bonded.

(Item 10) An identification system for associating a user with a digital agent acting as a digital persona of the user in a digital space, the system comprising:

a user information input unit configured to receive personal information of the user;

a biometric data obtaining apparatus configured to obtain biometric data from a biometric part of the user;

a biometric feature extraction unit configured to extract user-specific biometric features from the biometric data;

a biometric feature transformation unit configured to transform the user-specific biometric features into binary data suitable for computer processing;

an identification sequence generation unit configured to divide the binary data into a plurality of identification monomers corresponding to 2-bit units and generate an identification sequence comprising a chain-like array of the plurality of identification monomers;

an identification information storage unit configured to store an identifier of the digital agent based on the identification sequence;

a personal information storage unit configured to store the personal information of the user;

a storage unit provided within the digital agent and configured to store the identifier;

an identification search unit configured to match the identifier stored in the storage unit with the identifier stored in the identification information storage unit; and

an identification determination unit configured to associate the digital agent with the user based on a matching result from the identification search unit.

(Item 11) The system according to claim 10, wherein the biometric data obtaining apparatus comprises a sensor unit configured as a device separate from the user information input unit.

(Item 12) The system according to claim 10, wherein the user information input unit, the biometric data obtaining apparatus, the biometric feature extraction unit, the biometric feature transformation unit, and the identification sequence generation unit are provided within a same electronic device.

(Item 13) The system according to claim 10, further comprising an identification sequence editing unit configured to edit the identification sequence by performing at least one of mutation, recombination, substitution, inversion, deletion, insertion, or encryption.

(Item 14) The system according to claim 10, further comprising a reference sequence and a reference sequence editing unit configured to replace a part of the reference sequence with the identification sequence to generate the identifier of the digital agent.

(Item 15) The system according to claim 10, further comprising a biometric authentication unit configured to store the binary data of the user-specific biometric features as template data, generate query data from newly obtained biometric data, calculate a similarity between the template data and the query data, and determine whether to authenticate the user based on the similarity.

(Item 16) The system according to claim 10, further comprising a digital agent identifier calculation and generation unit configured to generate a third identification sequence for a third digital agent based on identification sequences of two digital agents, and a genealogical information storage unit configured to store genealogical information representing a relationship among the digital agents.

As used herein, the term “digital agent” may refer to a character serving as a user's alter ego in a digital space, or an autonomous digital agent acting autonomously in a virtual space. The form of the digital agent may be humanoid, animal, or plant, or it may be an AI agent having only intelligence without a physical form. Furthermore, it may be a cybernetic digital agent that creates value in the real world by operating the digital agent in the virtual space. “Digital agent” means a personal agent existing in a digital space, including avatars, intelligent agents, chatbots, generative AI, digital assets, and robot controllable from the digital space.

### Effects of the Invention

The identification system of the present disclosure has an advantage in that it can provide an identifier generation apparatus and an identification system that are excellent in confidentiality and high in reliability and scalability by utilizing a user's own biometric features when generating an identifier that associates a digital agent owner (user) with a digital agent serving as the user's digital persona in a digital space.

### BRIEF DESCRIPTION OF THE DRAWINGS

FIG. 1 is a diagram illustrating a schematic configuration of an identification system according to an embodiment of the present invention.

FIG. 2 is a diagram illustrating variations of the identification system Configuration.

FIG. 3 is an explanatory diagram for explaining an example of use of a sensor unit in an embodiment of the present invention.

FIG. 4 is an explanatory diagram for explaining an example of an image from which palm print information and vein information are extracted in an embodiment of the present invention.

FIG. 5 is a block diagram for explaining a process for generating biometric feature data in an embodiment of the present invention.

FIG. 6 is a block diagram for explaining a structure of an identifier in an embodiment of the present invention.

FIG. 7 is a block diagram for explaining a data structure in a server in an embodiment of the present invention.

FIG. 8 is a block diagram for explaining an outline of an identification process in an embodiment of the present invention.

FIG. 9 is an explanatory block diagram illustrating a configuration in which an identification sequence editing unit is added to an identifier generation apparatus in a second embodiment of the present invention (Variation 1).

FIG. 10 is a diagram illustrating a specific example of editing an identification sequence in the second embodiment of the present invention (Variation 1).

FIG. 11 is an explanatory block diagram illustrating a configuration in which a reference sequence is added to an identifier generation apparatus in a third embodiment of the present invention (Variation 2).

FIG. 12 is a diagram illustrating a specific example of a method for editing a reference sequence in the third embodiment of the present invention (Variation 1).

FIG. 13 is an explanatory block diagram illustrating a configuration in which a biometric authentication system is added in a fourth embodiment of the present invention (Example 2).

FIG. 14 is an explanatory block diagram illustrating a configuration in which pairing and genealogy of digital agents are described by blockchain in a fifth embodiment of the present invention (Example 3).

FIG. 15 is a block diagram explaining activation of pairing in the fifth embodiment of the present invention (Example 3).

FIG. 16 is an explanatory block diagram illustrating a configuration for generating an identifier of a newly produced digital agent by meiosis in a sixth embodiment of the present invention (Example 4).

FIG. 17 is a diagram explaining an identification sequence and an autosomal sequence in the sixth embodiment of the present invention (Example 4).

FIG. 18 is a diagram explaining meiosis in the sixth embodiment of the present invention (Example 4).

FIG. 19 is a diagram explaining a structure in a case where an identifier is made double-stranded in a seventh embodiment of the present invention (Example 5).

### DESCRIPTION OF EMBODIMENTS

Hereinafter, an embodiment of the present invention will be described with reference to the accompanying drawings.

### Example 1

### (System Configuration)

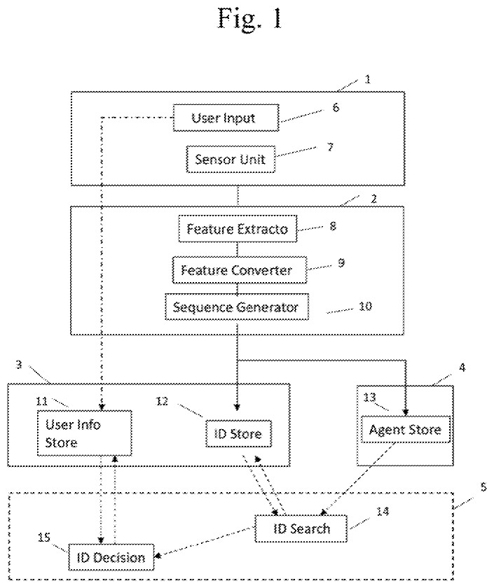

First, FIG. 1 illustrates an outline of the system configuration of the present embodiment.

A biometric data obtaining apparatus 1 of the present embodiment includes a user information input unit 6, through which a user inputs personal information. Furthermore, the biometric data obtaining apparatus 1 includes a sensor unit 7 and is configured to obtain a biometric image by capturing an image of a biological body (e.g., a palm, a face, an eye, or an entire body) with an image sensor, or to obtain digital signals of a biological body that vary over time or space (e.g., voice, heartbeat, etc.).

The aforementioned personal information and the biometric data associated with the personal information are transmitted, for example, via a communication path to an identifier generation apparatus 2.

The identifier generation apparatus 2 includes a biometric feature extraction unit 8 configured to extract user-specific biometric features from the biometric data. The biometric features are also utilized as template data for a biometric authentication system described later.

A biometric feature transformation unit 9 transforms the user-specific biometric features into binary data in a binary format suitable for computer processing. An identification sequence generation unit 10 divides the binary data into 2-bit units and transforms the binary data into chain-like array structure data having 2-bit binary data as a unit. This array data is referred to as an “identification sequence”. In the present embodiment, this identification sequence is directly utilized as an identifier of a digital agent.

The identifier is stored in a storage server 3. The system verifies whether the identifier overlaps with an existing identifier, and if there is no overlap, the identifier is stored in an identification information storage unit 12. In addition, the aforementioned personal information of the user is stored in a personal information storage unit 11. The identification information storage unit 12 and the personal information storage unit 11 may exist within the same server or may exist in separate servers. Further, the identifier generation apparatus 2 may be a processing device within a server.

Additionally, the identifier is stored in a storage unit 13 within the digital agent 4.

An identification processing apparatus 5 performs association between the digital agent and the user in response to an identification request. An identification search unit 14 matches the identifier stored in the digital agent 4 with the identifier stored in the identification information storage unit 12. An identification determination unit 15, in which determination rules for a case where matching identifiers are found are predefined, performs association with the user's personal information, such as a name, stored in the personal information storage unit 11 as necessary. Note that the identification processing apparatus 5 may be an independent server or a program executed within the storage server 3.

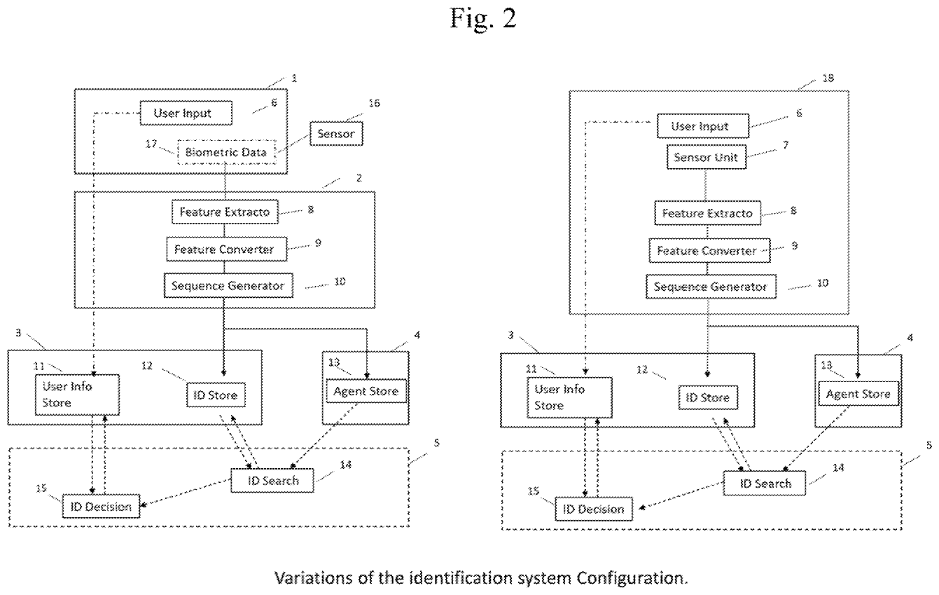

The above is one example of the system configuration. As shown in FIG. 2, for example, in a first variation, the biometric data obtaining apparatus 1 may be a PC, and the sensor unit 7 may be configured as a sensor device 16 connected via USB or the like. Alternatively, as in a second variation, the user information input unit 6, the sensor unit 7, the biometric feature extraction unit 8, the biometric feature transformation unit 9, and the identification sequence generation unit 10 may be provided within a single electronic device. Although various other system configurations are possible, the essence of the present invention lies in the method for generating an identifier; thus, further disclosure of system configuration examples is omitted.

Next, details of the method for generating an identifier will be described along with an example of the identification system.

### (Biometric Data Obtaining Apparatus)

A standard configuration of the biometric data obtaining apparatus 1 of the present embodiment includes the sensor unit 7 and the user information input unit 6.

### (Sensor Unit)

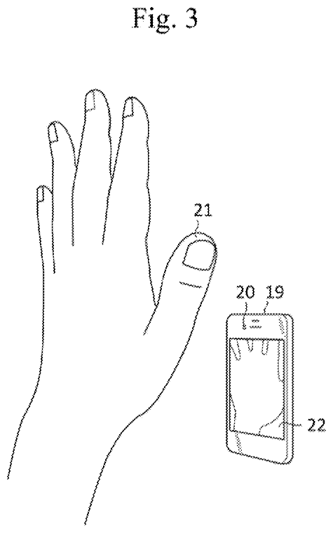

The sensor unit 7 in the present example is a camera 20 of a smartphone 19, as shown in FIG. 3. In the present example, the biometric part is a palm 21, and the user captures an image of the palm 21 with the camera 20 of the smartphone 19. To obtain the palm print shape and the vein shape as the biometric data of the present embodiment, it is necessary to irradiate the palm with light containing at least red light in the visible light region; thus, an LED light mounted on the smartphone 19 is utilized. The user is an owner of the digital agent and may sometimes also serve as a developer.

### (User Information Input Unit)

Furthermore, the biometric data obtaining apparatus 1 includes the user information input unit 6, which is configured for the user to input personal information. The personal information is information for identifying an individual, such as a name, a date of birth, an address, a nickname, a login ID, or a national ID, and may also be a credit card number or a driver's license number, provided that it is personal information for associating the user with an identification sequence for a digital agent described later. If the user is already within a virtual space, a login ID, a password, or a uniquely identifiable name of the digital agent may be used. In the present embodiment, since the biometric data obtaining apparatus 1 is the smartphone 19, an input function of the smartphone 19 displayed on a screen 22 may be used.

### (Identifier Generation Apparatus)

The identifier generation apparatus 2 includes the biometric feature extraction unit 8, the biometric feature transformation unit 9, and the identification sequence generation unit 10.

### (Biometric Feature Extraction Unit)

The biometric feature extraction unit 8 extracts features of the palm print shape and the vein shape from an image of the palm 21 captured by the camera 20 of the smartphone 19. Hereinafter, a method for extracting biometric features of the present embodiment will be described in detail.

Image processing is applied to the captured palm image such that the vein shape and the palm print shape appear strongly. According to the findings of the present inventor, a vein pattern appears most strongly in an M (magenta) signal in a CMYK color space, and a palm print shape is expressed in a G signal in an RGB color space. In addition to these two color signals, an R signal in the RGB color space, which tends to appear in both the vein and palm print shapes, is added, and further processing described below is performed to generate an image in which the vein shape and the palm print shape are emphasized.

In the present embodiment, the R signal and the G signal of the RGB color space are changed to an R′ signal and a G′ signal generated by attenuating saturation (S value) by 30% in a negative direction in an HSV space. Also, the M (magenta) signal in the CMYK color space is changed to an M′ signal generated by shifting a phase of H by +15° in the HSV space and further attenuating the S value by 30% in the negative direction. The range of the hue shift (i.e., the range of change) and the value of the saturation change are determined by experiments. Through the aforementioned processing, data in an R′, G', M′ signal space, which is different from the initial data in the RGB space and the CMYK space, can be obtained. In the present embodiment, the data in the R′, G′, M′ space thus obtained can each be expressed as an 8-bit (256 gradations) grayscale image.

GPvein=(α1*R′+α2*M′+α3*G′)

GPvein: grayscale data obtained from values of the R′ signal, G′ signal, and M′ signal;

R′: a value obtained by converting the value of the R signal in the RGB color space into the HSV color system, changing the saturation by (−30%), and returning it to the RGB color system;

G′: a value obtained by converting the value of the G signal in the RGB color space into the HSV color system, changing the saturation by (−30%), and returning it to the RGB color system; M′: a value obtained by converting the magenta signal in the CMYK color space into the HSV color system, changing the hue by (+15°) and the saturation by (−30%), and returning it to the CMYK color system;

α: coefficient (determined experimentally).

For example, optimal coefficient values as experimental values are GPvein (0.6*R′+0.6*M′−0.2*G′).

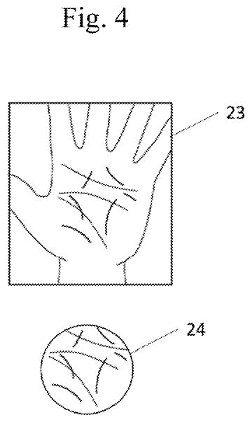

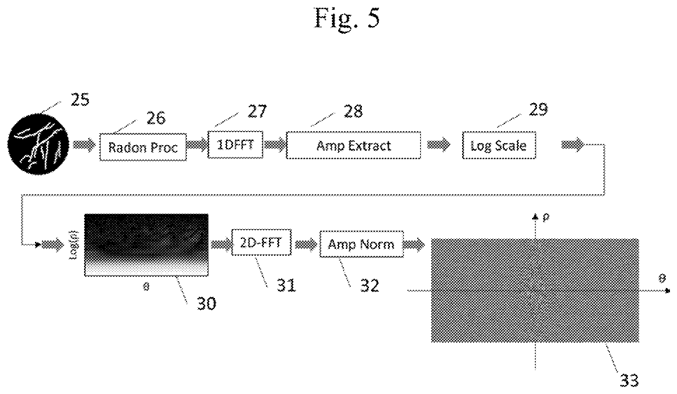

Next, by applying a filter for extracting line segments to the grayscale image, an image 23 in which the vein shape and the palm print shape are extracted is obtained as shown in FIG. 4. Furthermore, a circular region is set at the center of the palm, and a circular image 24 including the vein shape and the palm print shape within that region is obtained. For the obtained image 24, the following processing as shown in FIG. 5 is performed to obtain features that are invariant to linear transition, rotation, and scale.

As a method for extracting features, a Radon transform is used. This method expresses a two-dimensional image 25, in which palm print and vein shapes are emphasized, by projecting it onto an axis of a direction (θ=0 to 180°) and using a position on the projection axis.

Subsequently, a one-dimensional Fourier transform 27 is performed in a ρ direction on feature data 26 obtained by the Radon transform, and only an amplitude component thereof is extracted. Specifically, an amplitude component 28 is obtained by taking a square root of a sum of squares of a real part and an imaginary part after the Fourier transform. By extracting only the amplitude component 28, it becomes shift-invariant in the ρ direction.

Subsequently, a log-coordinate transform 29 is performed in the ρ direction. Specifically, ρ is transformed to log(ρ), and the feature data becomes a log-polar coordinate system. Data 30 in the log-polar coordinate system thus obtained serves as biometric features representing the features of the vein shape and the palm print shape.

### (Biometric Feature Transformation Unit)

The following processing is performed on the data 30 from which the biometric features are extracted to transform the user-specific biometric features into binary data in a binary format suitable for computer processing.

First, to facilitate calculation in a subsequent similarity calculation operation process, the feature extraction data 30 in the log-polar coordinate system is converted into a phase-only image from which only phases are extracted. Specifically, a Fourier transform 31 is performed on the feature extraction data 30 in the log-polar coordinate system, and processing 32 for setting an amplitude to 1 is performed. Since phase-only image conversion is also well known, detailed description is omitted. In the present embodiment, the data subjected to the Fourier transform serves as the biometric feature data.

The biometric feature data can be expressed as an N-dimensional vector. Specifically, the data subjected to the Fourier transform in the present example is a complex sequence of 256×128 elements, forming a 256×128=32,768-dimensional complex vector. Since the real part and the imaginary part of the 256×128=32,768-dimensional complex vector are each 8 bytes, it can be represented as 256×128×8=262,144 bits of biometric feature binary data 33. The real part and the imaginary part of a complex number are also well known, and thus description is omitted.

Binary data is in a binary format of numerals “0” and “1,” which is well known as a data format readable by a computer. As described above, in the present embodiment, the biometric features can be transformed into binary data represented by 262,144 digits of “0” and “1”.

### (Identification Sequence Generation Unit)

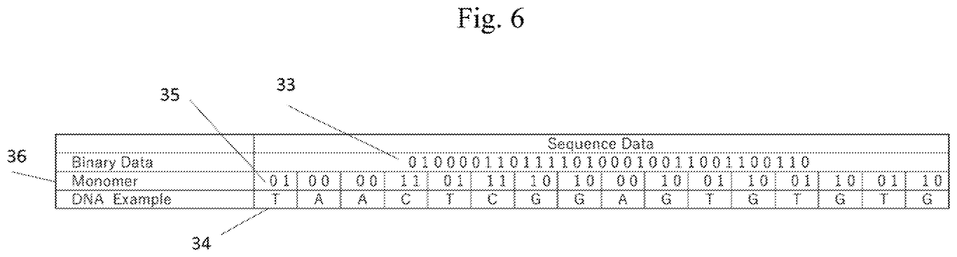

Here, considering combinations represented by two binary digits, there are four patterns: “00,” “01,” “10,” and “11”. By connecting the two binary digits of the aforementioned 262,144 digits as one unit, a chain-like structure having an array of 131,072 units is formed. As shown in FIG. 6, the two binary digits are referred to as an “identification monomer” 35, and an array structure in which the identification monomers 35 are linked in a chain is an “identification sequence” 36. This identification sequence 36 can be used as an identifier of a digital agent.

As described above, the biometric feature binary data 33, obtained by extracting individual biometric features from a biometric part image in the generation stage of the identification sequence 36, is data that can also be utilized as template data for biometric authentication. Since biometric authentication is a highly reliable individual authentication method and the data is highly unique, it is also possible to directly use the biometric feature binary data 33 as an identifier of a digital agent.

For example, if the two binary digits “00” of the identification monomer are replaced with A, “01” with T, “10” with G, and “11” with C, a structure analogous to biological DNA is formed as shown in the lower part of FIG. 6. As is widely known, biological DNA is a base sequence combining four substances: adenine (A), thymine (T), guanine (G), and cytosine (C). Therefore, since the identification sequence 36 of an autonomous digital agent has the same structure as biological DNA, it is possible to apply biological genetic diversity to the generation of an identifier.

### (Storage Server)

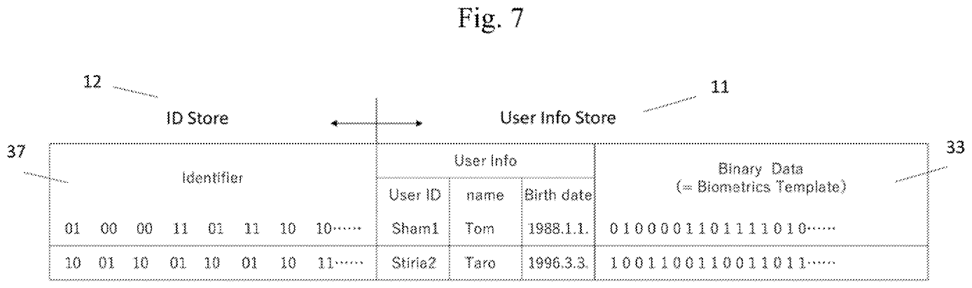

The storage server 3 includes the personal information storage unit 11 and the identification information storage unit 12. A basic configuration of a database within the server is as shown in FIG. 7.

### (Personal Information Storage Unit)

The user's personal information, such as a name, a user ID, and a user's date of birth, input through the input unit of the biometric data obtaining apparatus 1, is converted into a database and stored in the personal information storage unit 11. The user's personal information is uniquely associated with the identifier stored in the identification information storage unit 12.

Furthermore, the Fourier-transformed biometric feature binary data 33, generated by the biometric feature transformation unit 9 of the identifier generation apparatus 2, can also be stored in the personal information storage unit 11 as biometric authentication template data for a biometric authentication system described in a later example.

### (Identification Information Storage Unit)

An identifier is checked for overlap with existing identifiers, and if there is no overlap, it is converted into a database in the identification information storage unit 12.

The identification information storage unit 12 and the personal information storage unit 11 may exist within a single server. Alternatively, they may be independent servers configured to be able to perform database linkage.

In a case of performing database linkage, a database management unit configured to manage linkage among the identifier, the personal information, and the template data (the biometric feature binary data 33) utilized in the biometric authentication system may be provided.

### (Digital Agent Storage Unit)

a digital agent 4 in a virtual space includes the storage unit 13 and stores an identifier.

### (Identification Processing Apparatus)

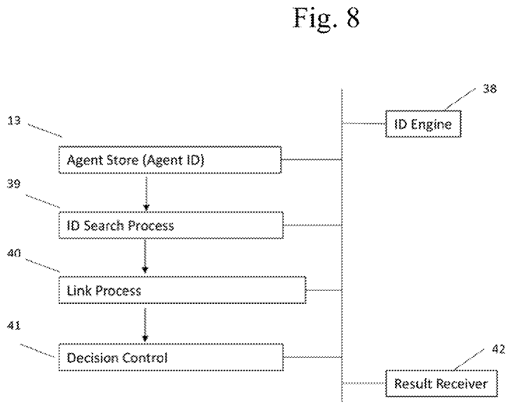

One simple example of an identification process will be described with reference to FIG. 8. First, an identification process drive unit 38 is configured to request the identification processing apparatus 5 to start an identification process when a predetermined condition is satisfied. An example where the identification process drive unit 38 and an identification result receiving unit 42 are smartphones, the identification processing apparatus 5 is in a server within a virtual space, and the storage server 3 is in a cloud will be described. For example, in a case where an identification request is only for confirming whether the digital agent 4 is registered in a membership-based virtual space, the requirement is satisfied by searching whether an identifier matching the identifier stored within the digital agent 4 exists in an identifier database of the identification information storage unit 12. In this case, presence or absence of a match is sent to an identification determination management unit 41, and if the process is correctly performed, an identification result is notified to the identification result receiving unit 42. For example, in a case where an identification request is for a user's name and date of birth, the system searches whether an identifier matching the identifier stored within the digital agent 4 exists in the identifier database of the identification information storage unit 12, and if a matching identifier exists, performs database linkage to extract the name and date of birth from the personal information storage unit 11. The extracted information is sent to the identification determination management unit 41, and if the process is correctly performed, an identification result is notified to the identification result receiving unit 42. The notification may be configured such that communication is performed via a network.

Regarding the identification process, although system configurations are diverse and individual detailed settings are expected for requested information, description is omitted because any of the examples are easy for database search design.

### Modification 1 of Biometric Data

Furthermore, the biometric data obtaining apparatus 1 can also have various configurations. The biometric part is a face. Although various technologies and algorithms exist as methods for extracting biometric features from a face image, a method where the biometric data obtaining apparatus 1 is a camera of a smartphone and the biometric feature extraction unit 8 is implemented by open source is shown here.

The biometric data obtaining apparatus 1 is a camera provided in a smartphone and captures a face image of the user. Hereinafter, a method for extracting features of a face from a face image will be described.

(1) Face Detection This is a step of detecting a person's face from an image. Only a face is cropped from the image and passed to a next step. A face detection algorithm can be implemented by a multitask convolutional neural network. Since details are open source and widely known, description is omitted.

(2) Feature Extraction This is a step of extracting (quantifying) features of a face from a face image. Using a well-known face recognition model for face recognition, a feature file having 512-dimensional (number of) values is eventually generated. This feature file is a biometric template 39. One description method of template data in the present modification is floating-point numbers of NumPy, which is specialized in numerical processing such as vector and matrix operations.

Since a method for converting floating-point numbers to binary is also well known, an outline is described below. In IEEE 754 single-precision (float, 32-bit) floating-point, 32 bits are divided into three parts: 1-bit “sign part,” 7-bit “mantissa part,” and 24-bit “exponent part,” and are expressed as binary data. For example, the number 125.0025 can be expressed as:

Sign part: 0;

Exponent part: 1000010;

Mantissa part: 111110100000000101001000.

Double-precision (double, 64-bit=8-byte) is similar in that it can be expressed as binary data. If binary data can be created, the identification sequence generation unit 10 can create the identification sequence 36 in a manner similar to that described above, store it in a server as an identifier, and store it in the digital agent 4.

There are various methods for face feature extraction; for example, local features can be Fourier-transformed to serve as biometric data. Since the biometric feature binary data 33 can be formed from a complex sequence in a manner similar to that described in Modification 1, subsequent processes can create the identification sequence 36 in a manner similar to the aforementioned method.

### Modification 2 of Biometric Data

An iris can also be used as biometric data. The sensor unit 7 of the biometric data obtaining apparatus 1 is a camera corresponding to near-infrared light, and obtains image data by capturing an eye region. After obtaining the data, an iris region is identified, and preprocessing for cropping only the iris region is performed. Thereafter, the iris region is divided into eight concentric layers, and after applying a filter, data called an “iris code” is created.

Since a method for converting floating-point numbers to binary is also well known, an outline is described below. In IEEE 754 single-precision (float, 32-bit) floating-point, 32 bits are divided into three parts: a 1-bit “sign part,” a 7-bit “mantissa part,” and a 24-bit “exponent part,” and are represented as binary data. For example, the number 125.0025 can be represented as: Sign part: 0; Exponent part: 1000010; Mantissa part: 111110100000000101001000.

Double-precision (double, 64-bit=8 bytes) is similar in that it can be represented as binary data. If binary data can be created, the identification sequence generation unit 10 can create the identification sequence 36 in a manner similar to that described above, store it in a server as an identifier, and store it in the digital agent 4.

There are various methods for face feature extraction; for example, local features can be Fourier-transformed to serve as biometric data. Since the biometric feature binary data 33 can be formed from a complex sequence in a manner similar to that described in Modification 1, subsequent processes can create the identification sequence 36 in a manner similar to the aforementioned method.

### Variation 1

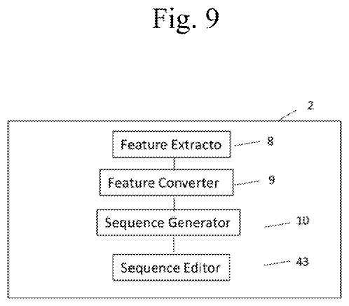

The following describes a variation of the first embodiment. As shown in FIG. 9, the identifier generation apparatus 2 of the Variation 1 includes the biometric feature extraction unit 8, the biometric feature transformation unit 9, the identification sequence generation unit 10, and an identification sequence editing unit 43.

Example 1 describes an example in which the identification sequence 36—which is chain-like array structure data having 2-bit units as one unit—is generated from biometric features and used directly as an identifier. However, Variation 1 addresses the need to edit the identification sequence 36 to generate an identifier to enhance confidentiality when assuming use in a virtual space.

Methods for editing include: a method of reorganizing an already generated identification sequence 36; a method of using a part of the sequence; a method of combining segments to form a whole; and a method of cutting and assembling constituent elements.

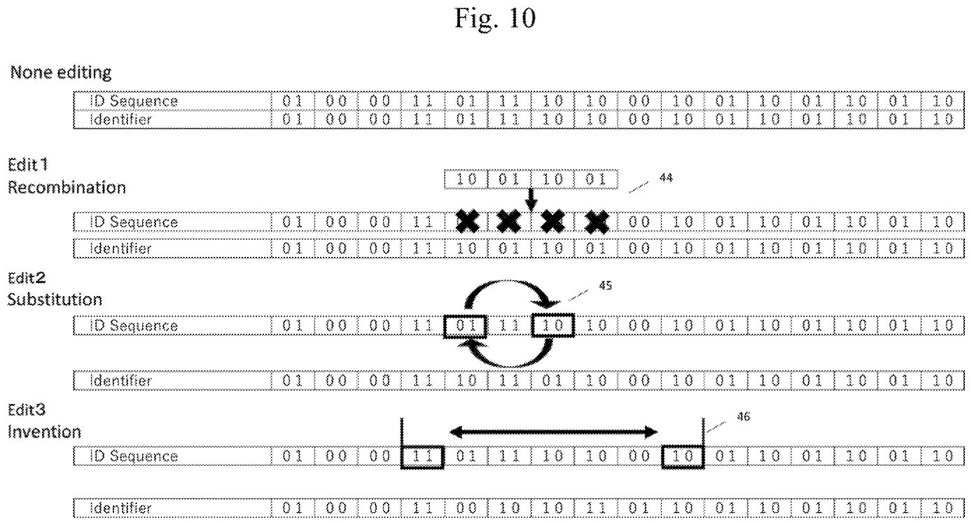

Specific examples are shown in FIG. 10. If no editing is performed, the identification sequence 36 directly becomes the identifier. In Edit Example 1, recombination is performed at a recombination part 44. In Edit Example 2, substitution is performed at a substitution part 45. In Edit Example 3, inversion is performed at an inversion part 46. In addition, various other edits including mutation, deletion, insertion, and encryption are possible.

It is preferable that the identification sequence 36 and the method and location of editing be recorded in the storage server 3 in association with the identifier.

### Variation 2

Furthermore, another variation of the first embodiment will be described below. Variation 2 is a method in which the system provides a reference sequence in advance, and a part of the reference sequence is replaced with the identification sequence 36 generated from the user's biometric data to generate an identifier of a digital agent.

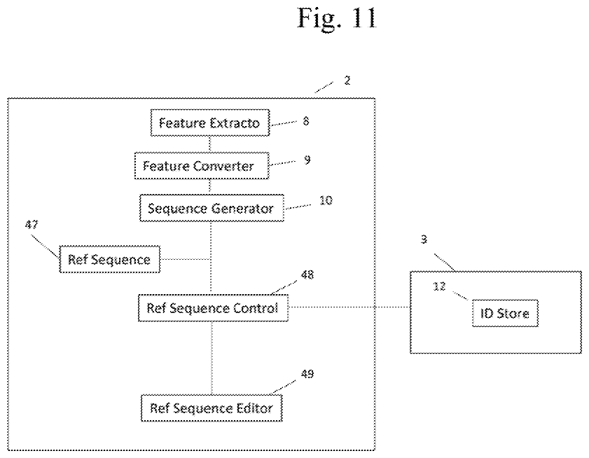

As shown in FIG. 11, the identifier generation apparatus 2 of the third embodiment includes the biometric feature extraction unit 8, the biometric feature transformation unit 9, and the identification sequence generation unit 10 described in Example 1, and further includes a reference sequence 47, a reference sequence organization management unit 48, and a reference sequence editing unit 49. Other system configurations are the same as those in Example 1, and thus redundant description is omitted.

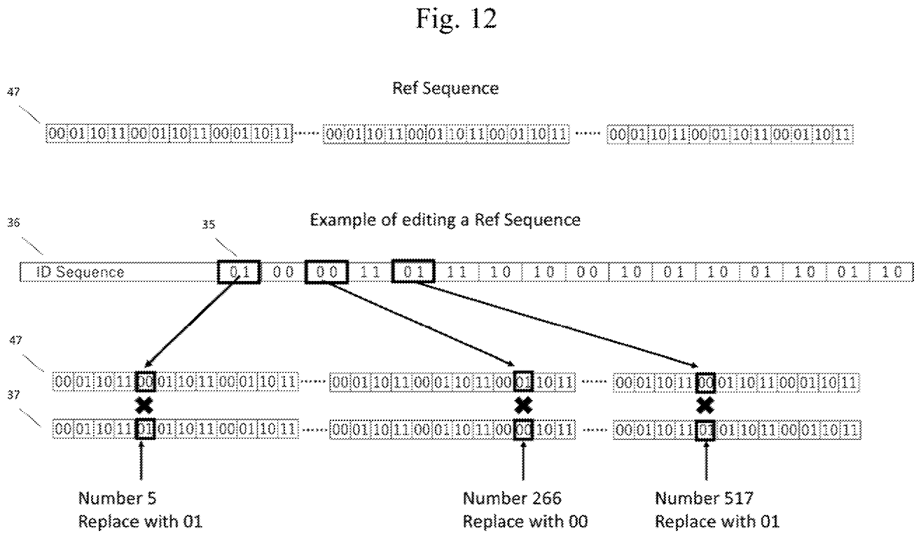

The reference sequence 47 serves as a standard array for the identifier of the digital agent 4 provided by the system. As shown in FIG. 12, the reference sequence organization management unit 48 manages rules or laws for replacing monomers of the identification sequence 36 of the digital agent with monomers of the reference sequence, and further includes a function of checking for overlap with other identifiers. The reference sequence editing unit 49 replaces the monomers of the identification sequence 36 with the monomers of the reference sequence based on the replacement rules to generate the identifier of the digital agent 4.

It is preferable that the identification sequence 36 of the digital agent 4, the position (number) where the replacement was performed, and information on the change be recorded in the storage server 3 in association with the identifier.

Example 1 describes that an identification sequence 36 having a chain-like array of 131,072 monomers can be generated. Modification 2 describes that an identification sequence 36 having an array of 1,024 monomers can be formed from an iris. In terms of identification efficiency, since there are four types of monomers as described above, a chain of 10 monomers yields 4\hat{ }10=1,048,576 possible combinations, which exceeds 10\hat{ }60. By extracting 200 monomers from the user's identification sequence 36 and replacing them into monomers on the reference sequence, almost infinite combinations become possible, enabling the identification of digital agents.

The method of replacing a part of the reference sequence with the user's monomers described above is similar to the method using “SNP (Single Nucleotide Polymorphism)” in human DNA testing. The total number of bases in human chromosomes is said to be 3 billion pairs. Among these, individual differences are approximately 0.1%, meaning 99.9% of the sequence is identical between individuals. The most common difference between individuals is the SNP, where only one base in the base sequence differs. Individual identification and testing are performed based on the position of the SNP on the gene and the SNP information at that position. Since this is an established technique in DNA testing, a highly reliable identification method can be provided for digital agent identification.

In a modification of the method described in Variation 2, it is also possible for the identifier stored in the storage unit 13 of the digital agent 4 to include only information on the position (number) where the replacement was performed on the reference sequence. Since the digital agent 4 exists in a digital space, this method enhances confidentiality, and the identifier can be generated by the reference sequence editing unit 49. In the case of humans, gene names and positions on chromosomes are maintained in genomic databases. For example, NCBI dbSNP managed by the National Center for Biotechnology Information is a database concerning human single nucleotide polymorphisms (SNPs). Since human gene loci (position information of sequences) are already widely known, further description thereof is omitted, but the identifiers of digital agents 4 can be similarly are stored in databases due to having the same structure as human DNA base sequences.

### Example 2

A second embodiment is a system that combines the identification system for the digital agent 4 with individual authentication based on the user's biological body.

### (System Configuration)

The identification system of the second embodiment includes a biometric authentication drive apparatus 50, a query sensor unit 51, a query biometric feature extraction unit 52, a query data generation unit 53, a matching unit 54, a determination unit 55, and a matching result receiving apparatus 56 added to the system configuration described in the first embodiment.

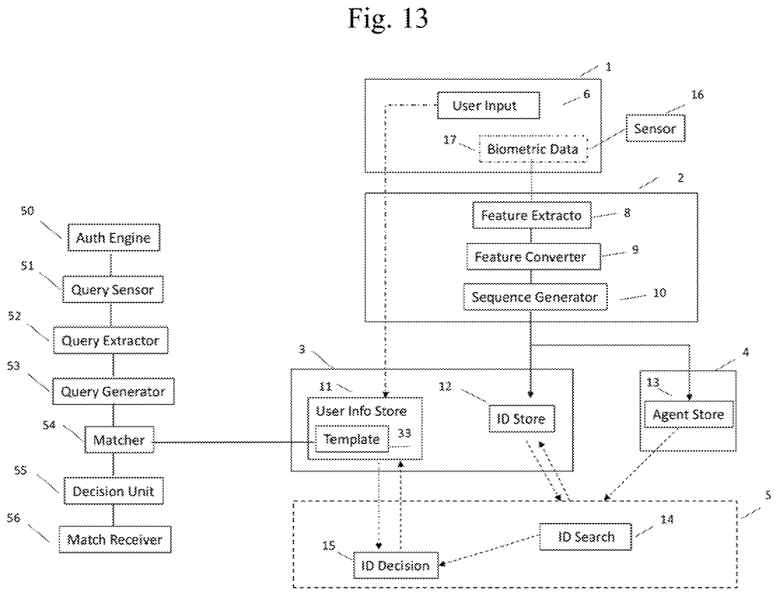

FIG. 13 illustrates the overall flow of individual authentication in the present embodiment. During authentication, the biometric authentication drive apparatus 50 starts the authentication process. The query sensor unit 51 obtains a query image by capturing the user's palm. Then, query data is generated using the query image. Subsequently, individual authentication is performed by matching the template data with the query data to determine similarity. The biometric feature binary data 33 stored in the personal information storage unit 11 of the storage server 3 is used as the template data.

### (Query Image Generation and Processing Method)

Hereinafter, processing of a query image will be described. The processing of a query image is basically executed in a manner similar to the generation process of biometric feature data when generating the identification sequence 36.

First, light containing at least red light in the visible light region is irradiated onto the user's palm. Then, the query sensor unit 51 obtains at least one reflection image composed of light reflected from the user's palm. Next, the query biometric feature extraction unit 52 performs image processing on the reflection image to extract biometric features based on the query palm print shape and vein shape in the palm from the single reflection image. Details of the image processing are the same as those for the biometric feature extraction unit 8. Furthermore, the query data generation unit 53 generates query binary data from the biometric features.

After the aforementioned processing, the matching unit 54 matches the template data with the query data to perform individual authentication using their similarity. In an example of authentication using similarity, phase-only correlation is calculated from the generated binary data sets. This allows for the calculation of a rotation angle (θ) and a scale (ρ) of the authentication image relative to the template data. In the present embodiment, the determination unit 55 determines the identity of the individual by adopting a value obtained from the maximum value of the phase-only correlation in the (ρ, θ) space or its surroundings as a threshold. Since the phase-only correlation method is a known technique, further detailed description is omitted. Methods other than phase-only correlation may also be used. The determination result is notified to the matching result receiving apparatus 56.

### Example 3

A third embodiment is a method for generating an identifier when a digital agent 4 having an identification sequence 36 bonds or pairs with another digital agent 4 having an identification sequence of the same format in a digital space to produce a new digital agent 4.

As described above, since the identifier of the digital agent 4 has the same structure as the DNA base structure that governs biological inheritance, genetic information of the digital agent 4 can be incorporated into and generated as the identifier.

### (System Configuration)

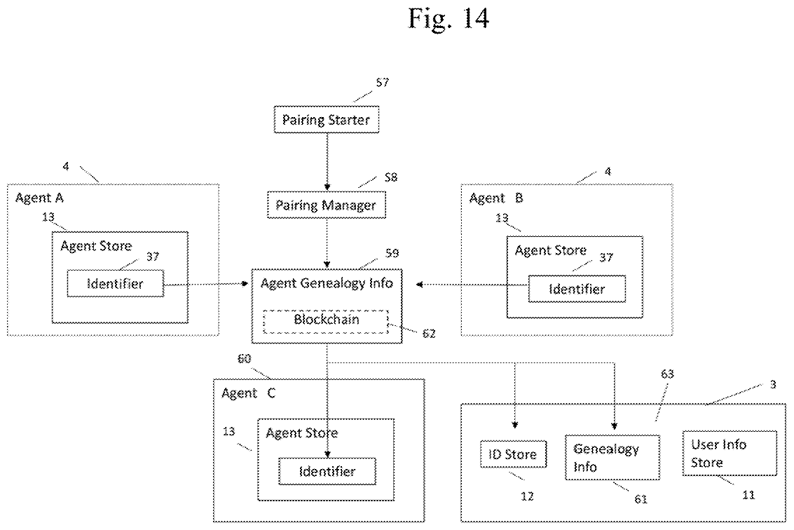

As shown in FIG. 14, at least two or more digital agents A and B, each having an identifier 37 in its storage unit 13, bond or pair to produce a new digital agent C. The system includes a pairing activation apparatus 57, a pairing management unit 58, an identifier calculation and generation unit 59, the newly produced digital agent 60, and a genealogical information storage unit 61 configured to store genealogical information 63 tracing back from the parent generation (one generation prior) of the digital agent to a first-generation digital agent.

### (Pairing Activation Apparatus)

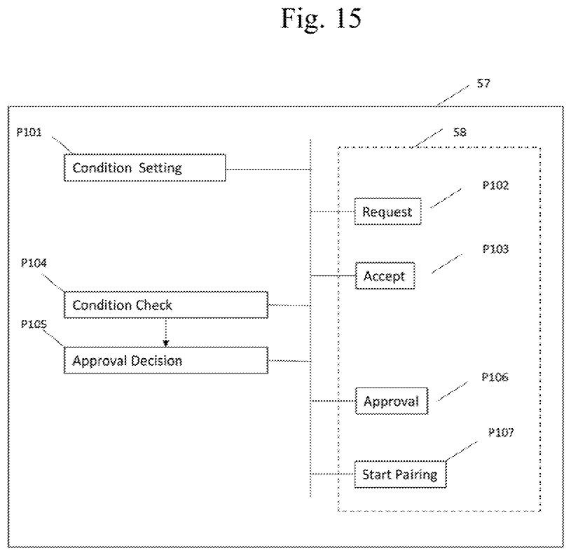

An example of an activation process by the pairing activation apparatus 57 will be described with reference to FIG. 15. Since the pairing management unit 58 is a part of the pairing activation apparatus 57, it will be described together.

(P101) Pairing Condition Setting Unit: Predefines pairing conditions when a user generates the digital agent 4, such as whether pairing is permitted, duration, frequency, number of generations allowed, conditions for the partner, and whether a user's permission is required.

(P102) Pairing Application: Performed by the pairing management unit 58 based on preset conditions or user action.

(P103) Pairing Reception: The pairing management unit 58 inquires with the partner digital agent 4 upon receiving an application.

(P104) Pairing Condition Confirmation: Verifies the pairing conditions.

(P105) Pairing Acceptance/Refusal Determination: Notifies the pairing management unit 58 of the decision.

(P106) Pairing Permission: Grants permission after re-verifying that conditions for both agents are satisfied.

(P107) Pairing Activation: Pairing begins.

### (Identifier Calculation and Generation Unit)

The identifier calculation and generation unit 59 generates an identifier for the newly produced digital agent 60 from the identifiers stored in the respective storage units 13 of the pairing digital agents 4.

The simplest method for generating the identifier is to create a blockchain 62 by combining the identifiers of both digital agents 4 and use it as the identifier of the newly produced digital agent 60. This method allows the entire pairing history to be recorded, which can be directly used as genealogical information. The identifier information is stored in the storage unit 13 of the digital agent 60 and in the identification information storage unit 12 of the storage server 3.

The genealogical information 63 is stored in the genealogical information storage unit 61 as a blockchain. A consortium-type blockchain managed by multiple administrators is suitable, and it is preferable to maintain transparency by allowing the pairing history to be viewed via a blockchain explorer.

Although a blockchain is used as the identifier here, the present invention is not particularly limited to a blockchain. For example, assuming pairing always involves two agents, the number of ancestors reaches over 2 billion at 30 generations back and over 2 trillion at 40 generations back. Since storing all this in the digital agent 4 is practically impossible, it is preferable to use a hash value from the blockchain generation of the pairing or combine it with the method described in the next section.

### Example 4

A fourth embodiment provides an “ trait sequence (also referred to as an autosomal-like sequence)” that enables determination of external or internal traits of a digital agent from genetic information, in addition to the identification sequence 36 for clarifying genealogy, as genetic information for the newly produced digital agent 60 disclosed in the third embodiment.

An autosomal sequence has determinants such as shape, style, color, personality, property, intelligence, intellect, gender, and species, and enables physical and internal traits of a digital agent to be determined from genetic information.

### (System Configuration)

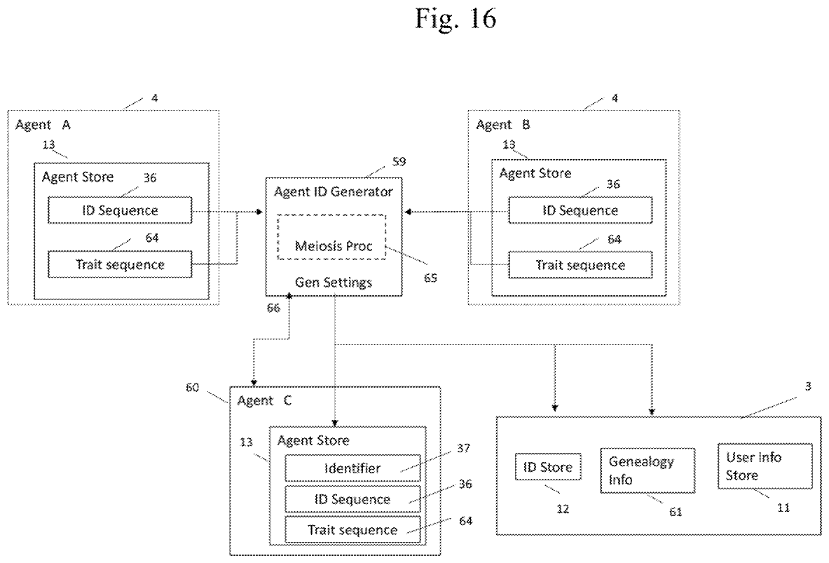

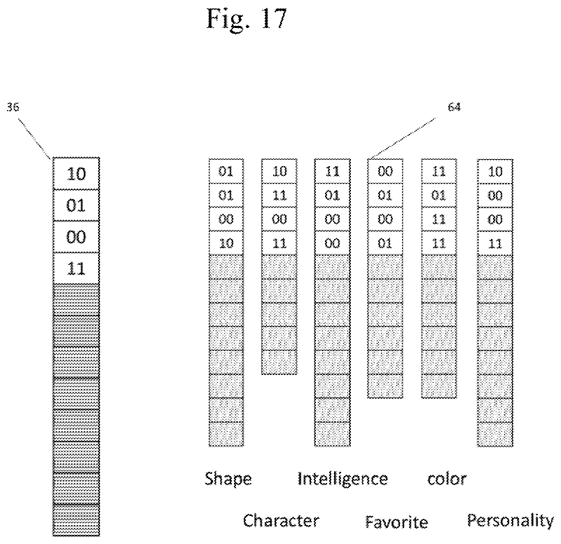

FIG. 16 illustrates a system configuration of the fourth embodiment. The identification sequence 36 and an autosomal sequence 64 are stored in the storage unit 13 of the digital agent 4. Their structures are shown in FIG. 17. The identification sequence 36 is always a single array of linked monomers. The number of autosomal sequences 64 is not particularly limited, but physical and internal traits are described in a chain-like manner as genetic information. Upon activation of pairing, digital agents A and B pair, and the identifier of a newly produced digital agent C is generated by meiosis. In this case, the identifier and the identification sequence 36 are the same array.

Similarly, the autosomal sequence 64 of digital agent C is generated by meiosis, and traits are determined and created according to a digital agent production setting 66.

The identification sequence 36 and the autosomal sequence 64 are stored in the storage unit 13 of the newly produced digital agent C. The identifier of digital agent C is stored in the identification information storage unit 12, and the genealogical information is stored in the genealogical information storage unit 61.

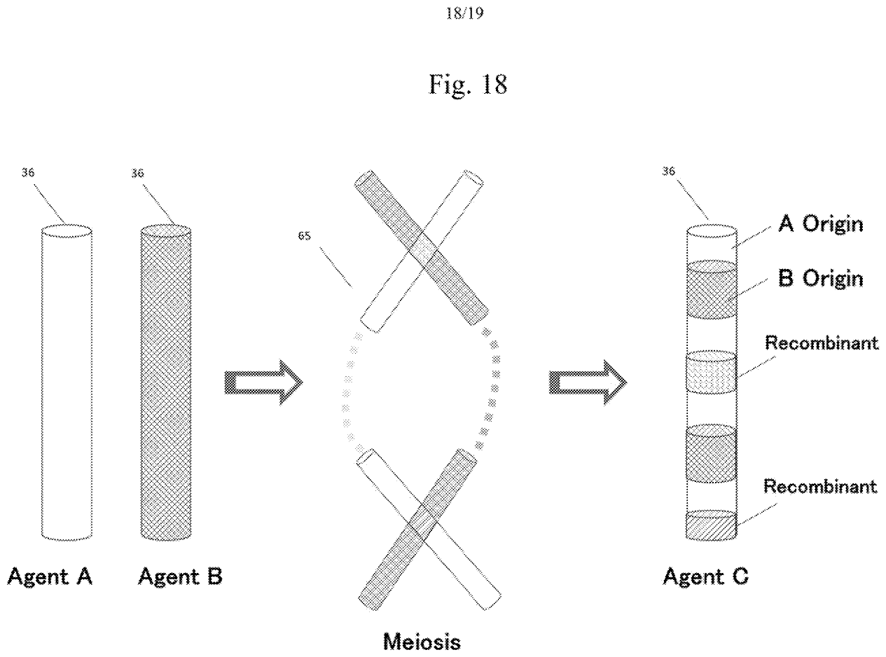

FIG. 18 illustrates a biological model of meiosis. This biological model shows how an extremely large number of combinations can be generated from a limited set of basic units. A similar concept is applied to the generation of identifiers for digital agents, in which combinations of identification monomers produce a vast classification space even with relatively short sequences.

If the number of identification sequences of digital agents is set to a level similar to humans, a sufficient number of combinations for identification performance can be achieved.

### Example 5

While the identifier has been described as having a single-stranded structure, it may also have a double-stranded structure or a double-stranded or double-helix-like structure similar to human DNA.

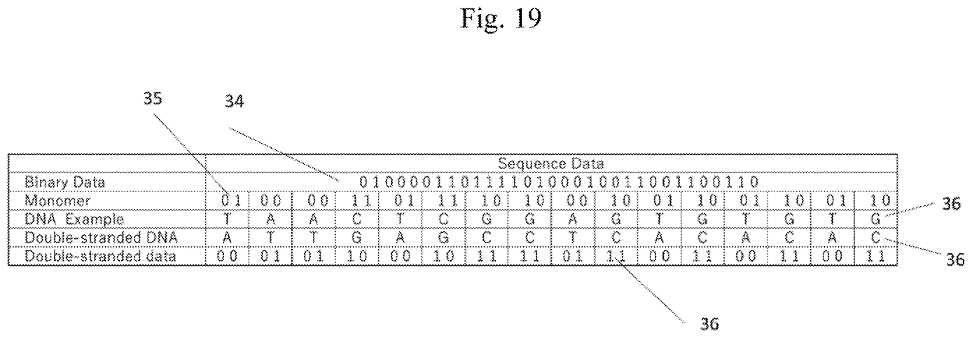

As described above, the identification sequence 36 is a structure in which identification monomers 35 are linked in a chain. The identification monomer 35 is composed of binary 2-digit “00,” “01,” “10,” or “11”. Here, by configuring “00” to always pair with “01” and “10” to always pair with “11,” a complementary structure is formed where the sequence of one strand allows the sequence of the pair to be known (see FIG. 19).

Human chromosomes are known to have a double-helix structure with paired bases, where adenine (A) always pairs with thymine (T) and guanine (G) always pairs with cytosine (C). The present invention can be considered to have a similar structure.

Configuring the identifier 37, the identification sequence 36, and the autosomal sequence 64 of a digital agent in a double-stranded structure provides functional benefits as well as structural ones. For example, if an identifier is tampered with, it can be easily repaired if one strand is preserved. This enables usage similar to the concept of cancelable biometrics, in which compromised biometric data can be regenerated or replaced which is a mainstream technology in biometric authentication.

Configurations other than those described above are basically the same as those in any one of the first to fourth embodiments, and thus further detailed description is omitted.

### REFERENCE SIGNS LIST

1 biometric data obtaining apparatus
2 identifier generation apparatus
3 storage server
4 digital agent
5 identification processing apparatus
6 user information input unit
7 sensor unit
8 biometric feature extraction unit
9 biometric feature transformation unit
10 identification sequence generation unit
11 personal information storage unit
12 identification information storage unit
13 storage unit
14 identification search unit
15 identification determination unit
16 sensor
17 biometric data
18 electronic device
19 smartphone
20 camera
21 palm
22 display screen
23 extracted palm-print and vein image
24 generated biometric feature data image
25 palm-print and vein pattern image
26 Radon transform processing
27 one-dimensional Fourier transform processing
28 amplitude extraction processing
29 logarithmic scaling processing
30 log polar coordinate biometric data
31 two-dimensional Fourier transform processing
32 amplitude normalization processing
33 Fourier-transformed biometric feature binary data
34 example of human nucleotide sequence
35 identification monomer
36 identification sequence
37 identifier
38 identification execution unit
39 identifier search processing
40 linkage processing
41 identification determination management
42 identification result receiving unit
43 identification sequence editing unit
44 recombination region
45 substitution region
46 inversion region
47 reference sequence
48 reference sequence arrangement management unit
49 reference sequence editing unit
50 biometric authentication execution apparatus
51 query sensor unit
52 query biometric feature extraction unit
53 query data generation unit
54 matching unit
55 determination unit
56 matching result receiving apparatus
57 pairing activation apparatus
58 pairing management unit
59 digital agent identifier calculation and generation unit
60 newly generated digital agent
61 genealogical information storage unit
62 blockchain
63 genealogical information
64 trait sequence
65 meiotic processing
66 digital agent generation settings
P101 pairing condition setting unit
P102 pairing request
P103 pairing acceptance
P104 pairing condition confirmation
P105 pairing approval determination
P106 pairing approval
P107 pairing activation

1. A method for generating an identifier for associating a user with a digital agent acting as a digital persona of the user in a digital space, the method comprising:
obtaining biometric data from a biometric part of the user;
extracting, by a processor, user specific biometric features from the biometric data;
transforming, by the processor, the user specific biometric features into binary data suitable for computer processing;
dividing, by the processor, the binary data into a plurality of identification monomers, each identification monomer corresponding to a 2 bit unit of the binary data;
generating an identification sequence comprising a chain like array of the plurality of identification monomers; and
defining an identifier of the digital agent based on the identification sequence.

2. The method according to claim 1, wherein the identifier of the digital agent is the identification sequence.

3. The method according to claim 1, further comprising editing the identification sequence by performing at least one of mutation, recombination, substitution, inversion, deletion, insertion, or encryption, and defining the edited identification sequence as the identifier of the digital agent.

4. The method according to claim 1, further comprising providing a reference sequence and replacing a part of the reference sequence with the identification sequence to generate the identifier of the digital agent.

5. The method according to claim 4, wherein the identifier of the digital agent is defined as position information on the reference sequence where the replacement was performed.

6. The method according to claim 1, further comprising generating a third identification sequence for a third digital agent based on a first identification sequence of a first digital agent and a second identification sequence of a second digital agent.

7. The method according to claim 6, further comprising storing, in a server, genealogical information representing a relationship among the first digital agent, the second digital agent, and the third digital agent.

8. The method according to claim 1, wherein the digital agent further comprises a trait sequence in addition to the identification sequence, the trait sequence including at least one determinant of a shape, a style, a color, a personality, a property, an intelligence, an intellect, a gender, or a species of the digital agent.

9. The method according to claim 1, wherein a data array of the identifier has a single stranded structure or a double stranded structure in which single stranded data arrays are complementarily bonded.

10. An identification system for associating a user with a digital agent acting as a digital persona of the user in a digital space, the system comprising:
a user information input unit configured to receive personal information of the user;
a biometric data obtaining apparatus configured to obtain biometric data from a biometric part of the user;
a biometric feature extraction unit configured to extract user specific biometric features from the biometric data;
a biometric feature transformation unit configured to transform the user specific biometric features into binary data suitable for computer processing;
an identification sequence generation unit configured to divide the binary data into a plurality of identification monomers corresponding to 2 bit units and generate an identification sequence comprising a chain like array of the plurality of identification monomers;
an identification information storage unit configured to store an identifier of the digital agent based on the identification sequence;
a personal information storage unit configured to store the personal information of the user;
a storage unit provided within the digital agent and configured to store the identifier;
an identification search unit configured to match the identifier stored in the storage unit with the identifier stored in the identification information storage unit; and
an identification determination unit configured to associate the digital agent with the user based on a matching result from the identification search unit.

11. The system according to claim 10, wherein the biometric data obtaining apparatus comprises a sensor unit configured as a device separate from the user information input unit.

12. The system according to claim 10, wherein the user information input unit, the biometric data obtaining apparatus, the biometric feature extraction unit, the biometric feature transformation unit, and the identification sequence generation unit are provided within a same electronic device.

13. The system according to claim 10, further comprising an identification sequence editing unit configured to edit the identification sequence by performing at least one of mutation, recombination, substitution, inversion, deletion, insertion, or encryption.

14. The system according to claim 10, further comprising a reference sequence and a reference sequence editing unit configured to replace a part of the reference sequence with the identification sequence to generate the identifier of the digital agent.

15. The system according to claim 10, further comprising a biometric authentication unit configured to store the binary data of the user specific biometric features as template data, generate query data from newly obtained biometric data, calculate a similarity between the template data and the query data, and determine whether to authenticate the user based on the similarity.

16. The system according to claim 10, further comprising a digital agent identifier calculation and generation unit configured to generate a third identification sequence for a third digital agent based on identification sequences of two digital agents, and a genealogical information storage unit configured to store genealogical information representing a relationship among the digital agents.
